(19) United States
(12) Patent Application Publication
(10) Pub. No.: US 2015/0194082 A1
(43) Pub. Date: Jul. 9, 2015

(54) SYSTEMS, DEVICES, AND METHODS FOR DISPLAYING ACCESSORIES AND INFORMATION FROM A VEHICLE

(71) Applicant: John Arthur McEwan, Alexandria, VA (US)

(72) Inventor: John Arthur McEwan, Alexandria, VA (US)

(21) Appl. No.: 14/147,280

(22) Filed: Jan. 3, 2014

(51) Int. Cl. G09F 21/04; B23P 19/04; B60Q 1/56; B60R 13/10; G09F 13/20

(52) U.S. Cl. CPC G09F 21/048; B60R 13/105; G09F 13/20; B60Q 1/56; B23P 19/04; G09F 2013/222

(57) ABSTRACT

Systems, devices, and methods incorporate accessories into the body of a vehicle while maintaining the vehicle's original shape and aesthetic characteristics. In some cases, the accessories may be license plates, registration/inspection stickers, parking/security passes, bumper stickers, taxicab medallions, or any object that is typically attached to, and displayed from, the outer surface of a vehicle. In other embodiments, the accessories may be electrically controlled devices that display text and/or graphic images from the vehicle. In an example embodiment, a system for displaying accessories from a vehicle includes a window disposed along an outer surface of the vehicle. The window includes an at least partially translucent portion. The system also includes an attachment mechanism that secures an accessory inside the outer surface of the vehicle and behind the window of the display system. The attachment mechanism positions the accessory to be visible through the at least partially translucent portion.

### FIELD OF THE INVENTION

The disclosed subject matter pertains generally to vehicle accessories, and more particularly, to systems, devices, and methods that allow accessories (e.g., license plates) and corresponding information to be displayed from cars, trucks, motorcycles, and/or other vehicles while generally maintaining desired aesthetic characteristics for the vehicles.

### BACKGROUND

Many government bodies and other institutions require owners of cars, trucks, motorcycles, etc., to display license plates or other accessories on the front and/or back of their vehicles. These accessories are generally attached to vehicles using an attachment mechanism mounted onto the outer surface of the vehicle.

Vehicle owners may also want to attach bumper stickers to their vehicles to customize or personalize their vehicles. With bumper stickers, vehicle owners can, for example, proclaim their support for sports teams or political causes, publicize places where they have traveled, or make amusing statements. Bumper stickers are generally attached to vehicles using an adhesive that secures the bumper stickers to the outer surface of the vehicle.

### BRIEF SUMMARY

According to aspects of the present invention, systems, devices, and methods allow accessories to be incorporated into the body of a vehicle (e.g., car, truck, motorcycle, etc.) while maintaining the vehicle's original shape and aesthetic characteristics. In some cases, the accessories may be license plates. In other cases, the accessories may be registration/inspection stickers, parking/security passes, bumper stickers, taxicab medallions, or any object that is typically attached to, and displayed from, the outer surface of a vehicle. In yet other embodiments, the accessories may be electrically controlled devices that display text and/or graphic images from the vehicle.

In an example embodiment, a system for displaying accessories from a vehicle includes a window configured to be disposed along an outer surface of the vehicle. The window includes an at least partially translucent portion. The system also includes an attachment mechanism configured to secure an accessory inside the outer surface of the vehicle and behind the window of the display system. The attachment mechanism positions the accessory relative to the window so that the accessory is visible from outside the outer surface of the vehicle through the at least partially translucent portion.

These and other aspects of the present disclosure will become more apparent from the following detailed description of embodiments of the present disclosure when viewed in conjunction with the accompanying drawings.

### BRIEF DESCRIPTION OF THE DRAWINGS

FIG. 1 illustrates a vehicle incorporating a display system, according to aspects of the present invention;

FIG. 2A illustrates a front view of an example display system, according to aspects of the present invention;

FIG. 2B illustrates a rear view of the display system of FIG. 2A, according to aspects of the present invention; and

FIG. 3 illustrates another example vehicle incorporating a display system, according to aspects of the present invention.

FIG. 4A illustrates an example configuration for a display system, according to aspects of the present invention.

FIG. 4B illustrates another example configuration for a display system, according to aspects of the present invention.

FIG. 5A illustrates another example vehicle incorporating a display system showing information, according to aspects of the present invention.

FIG. 5B illustrates the example vehicle of FIG. 5A with different information shown by the display system, according to aspects of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

According to aspects of the present invention, systems, devices, and methods allow accessories to be incorporated into the body of a vehicle (e.g., car, truck, motorcycle, etc.) while maintaining the vehicle's original shape and aesthetic characteristics. In some embodiments, the accessories may be license plates, transponders for paying tolls, or any object that is typically mounted on the outer surface of a vehicle. In other embodiments, the accessories may be registration/inspection stickers, parking/security passes, bumper stickers, taxicab medallions, or any object that is typically attached to, and displayed from, the outer surface of a vehicle. In yet other embodiments, the accessories may be electrically controlled devices that display text and/or graphic images from the vehicle.

Mounting license plates and/or other accessories to the outer surface of the vehicle using an external attachment mechanism makes dramatic and unwanted changes to the appearance of the vehicle. Vehicle manufacturers spend significant time and money designing the vehicles to make them aesthetically pleasing to consumers, only to have the appearance of the vehicles altered by these external attachments. Indeed, when vehicle sellers advertise or display their vehicles, the vehicles are often shown without license plates mounted on them as the license plates make the vehicles less appealing. Similarly, vehicle owners spend significant time and money customizing the appearance of their vehicles, only to have the appearance of the vehicles ruined by these external attachments.

As described above, many government bodies require owners of cars, trucks, motorcycles, etc., to display license plates on the front and/or back of their vehicles. To obey government regulations, vehicle owners have had no choice but to make unappealing changes to their vehicles by mounting license plates to the outer surface of their vehicles. Alternatively, vehicle owners may choose to subject themselves to fines and other legal penalties by purposely deciding not to mount the license plates to their vehicles. Parked vehicles without license plates can be ticketed and towed. In addition, law enforcement bodies often track vehicles with cameras mounted on roadways, toll booths, or law enforcement vehicles; and owners of vehicles seen on camera without license plates can receive tickets. Indeed, the increasing dependence upon these types of cameras has resulted in more states requiring the mounting of license plates on the front of a vehicle.

In addition, when license plates are attached externally to the vehicle, they are more prone to theft or vandalism. For example, in some states annual registration stickers must be displayed on license plates, but are prone to theft because the license plates are easily accessible. Further, license plates mounted on the outer surface of the vehicle are more susceptible to collecting dirt and debris which can obscure the information on the license plates.

Moreover, nose cones and other aspects of vehicles are contoured to make the vehicles aerodynamic and to reduce a vehicle's coefficient of drag. As the price of fuel rises, efficiency and a low coefficient of drag have become increasingly important. When a license plate, for example, is placed on the outer surface of the vehicle's nose cone, the license plate and its attachment mechanism extend outwardly from the surface of the vehicle, preventing the formation of an aerodynamic flow that is conducive to minimizing drag.

Indeed, due to the rising cost of fuel, there is rising demand for fuel efficient cars, such as hybrid and electric vehicles. Such vehicles generally require smaller grills or no grills to receive air for running, e.g. cooling, the engine. With the surface area previously devoted to larger grills now available, vehicle manufacturers are able to exercise more creativity and design the front of vehicles to be more aesthetically appealing and distinctive. Mounting license plates to the outer surface of the front of the vehicle makes dramatic and unwanted changes to these increasingly appealing and distinctive designs.

Historically, vehicles have had larger bumpers as well as larger grills. As grills became smaller, bumpers changed as well. Bumpers are now covered with a skin that is shaped and colored to complement the general aesthetic features of the vehicle. Indeed, the shock-absorbing function of the bumper has become less visually apparent.

Using the systems, devices, and methods disclosed herein, vehicle owners can maintain the desired appearance and performance of their vehicles while still meeting the requirements of their governments and other regulatory bodies to display license plates and/or other accessories from the vehicle and avoiding the risk of fines or other legal penalties.

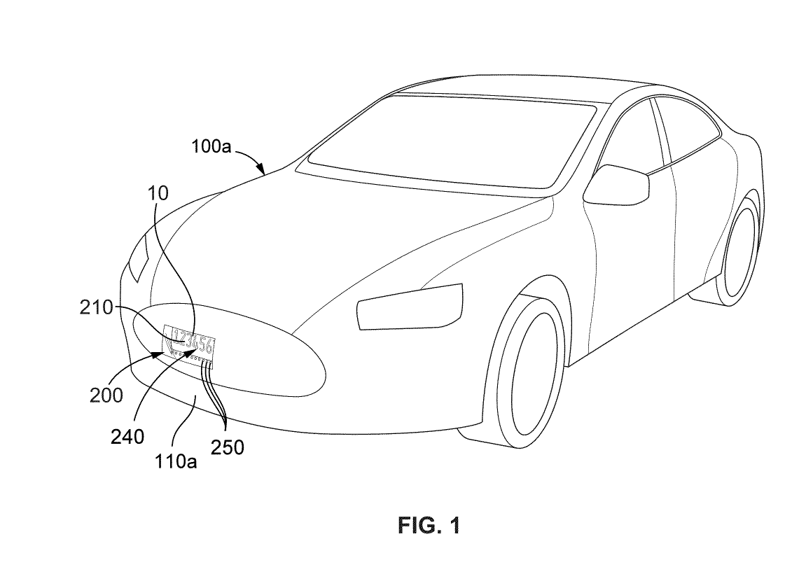

FIG. 1 illustrates a vehicle 100a incorporating an example display system 200 that displays an accessory from the vehicle 100a, according to aspects of the present invention. The vehicle 100a includes an outer surface 110a on the front of the vehicle 100a. As shown, the display 200 system holds and displays a license plate 10 from inside the outer surface 110a. It is understood, however, that the license plate 10 is described only as an example of an accessory that can be held by the display system 200. As described above, the display system 200 can hold and display license plates, transponders for paying tolls, registration/inspection stickers, parking/security passes, bumper stickers, taxicab medallions, or any objects that can be displayed from the vehicle. In addition, it is understood that the display systems described herein can be configured to display any number and combination of accessories. Moreover, it is understood that the display systems described herein are not limited to use on the front of vehicles and may be employed to display any accessories from any part of a vehicle, e.g., the rear bumper.

The display system 200 is configured so that it does not disrupt the contours of the outer surface 110a of the vehicle 100a. In some cases, the display system 200 may even enhance the appearance of the vehicle 100a. Contrary to other systems where the license plate 10 would be mounted on, and extend outwardly from, the outer surface 110a of the vehicle 100a, the display system 200 holds the license plate 10 so that the license plate 10 is disposed within the outer surface 110a of the vehicle 100a. In other words, the license plate 10 is generally disposed in a recess formed by the display system 200, so that the license plate 10 is not situated on the outer surface 110a. The display system 200 integrates the license plate 10 into the general aesthetic scheme of the vehicle 100a, rather than making the display of the license plate 10 appear to be an after-thought.

The display 200 includes a window 210, which includes a transparent or partially transparent portion through which the license plate 10 is visible from outside the vehicle 100a. The term “window” as used herein is understood to include any surface through which one can view at least partially an object disposed on the opposing side of the surface. The window 210 is disposed along the outer surface 110a of the vehicle and is contoured to be consistent with, or otherwise complement, the surrounding contours of the outer surface 110a. In other words, the window 210 of the display system 200 and the outer surface 110a of the vehicle 100a may combine to form one substantially continuous contour. The outer edges of the window 210, for example, may be generally flush with the surrounding vehicle outer surface.

The window 210 is configured to complement the aesthetic appearance of the vehicle 100a, e.g., make and model, etc. Although the window 210 shown in FIG. 1 is shown as having a rectangular shape, it is understood that the window in other embodiments may have other shapes, e.g., oval, circle, etc., and other dimensions.

Often vehicle manufacturers sculpt recesses in the front or rear panels of vehicles to allow license plates to be mounted onto the outer surface of the vehicles. Such recesses, however, may only be able to accommodate certain license plate sizes. For example, some cars may have a rear panel that is sculpted to receive a license plate from any of the fifty United States but not differently dimensioned license plates from a European country. Display systems according to aspects of the present invention, however, can accommodate license plates and accessories of varying sizes without requiring vehicle manufacturers to reshape vehicles and altering their original design.

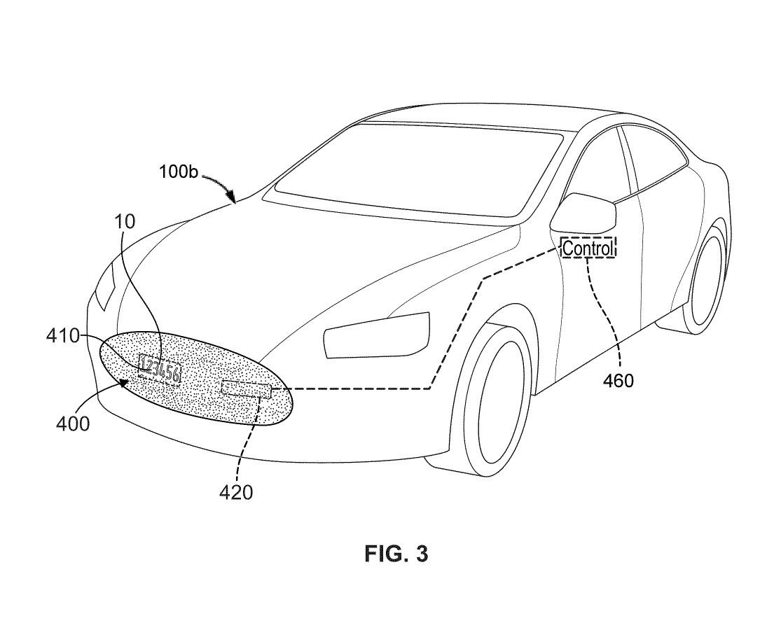

The window 210 may also be tinted or otherwise colored by the vehicle manufacturer or owner to complement or even enhance the overall appearance of the vehicle 100a. For example, aspects of the window 210 may have a smoked appearance, similar to smoked glass. A black smoked appearance, for instance, may aesthetically complement a black outer surface 110a for the vehicle 100a. Additionally, the window 210 may have a gradient of opacity. For example, the window 210 may appear darkest or fully opaque along its periphery and may gradually appear lighter and more transparent closer to the portion where the license plate information is shown. (An example of this gradient of opacity is described below with reference to FIG. 3.) In general, the window 210 may employ any combination of tints or colors, and different portions of the window 210 may have varying levels of opaqueness/transparency.

The window 210 may be formed from any combination of materials having the desired translucent characteristics, including different types of glass or plastic. Additionally, the window 210 may formed with any combination of materials that provide the desired indices of refraction that minimize visual distortions and other unwanted optical effects when viewing the license plate 10 through the window 210. Correspondingly, the window 210 may be configured to have particular thicknesses at determined portions so that the license plate 10 is clearly visible through the window. In effect, the window 210 may be formed from any combination of materials (e.g., with varying indices of refraction) and any dimensions so that the window 210 can act as a lens that provides desired, or enhanced, visibility for the license plate 10.

The display system 200 includes an attachment mechanism 240 that positions and secures the license plate 10 behind the window 210, where the license plate 10 is visible from outside the vehicle 100a. In some embodiments, the license plate 10 is coupled directly to the window 210. In other embodiments, the license plate 10 is coupled directly to a structure of the vehicle 100a. The attachment mechanism 240 may employ any number and combination of screws, nuts/bolts, pins, magnets, adhesives, brackets, snap mechanisms, or other fastening techniques to engage different portions, e.g., sides, corners, etc., of the license plate 10.

The display system 200 also includes one or more lights 250 to illuminate the license plate 10 and enhance its visibility through the window 210. These lights 250 may include any combination of light emitting diodes (LEDs), incandescent bulbs, neon lights, fluorescent lights, etc. As shown in FIG. 1, the lights 250 are disposed beneath the license plate 10, but in other embodiments, the lights 250 may be disposed at different appropriate locations to enhance the visibility of the license plate 10 through the window 210. In some embodiments, the lights 250 are turned on automatically when the vehicle 100a is started or when the vehicle's headlights are turned on. In other embodiments, the lights 250 are selectively operated by the operator, e.g., through a switch or other control in the vehicle's interior instrument panel. If the vehicle 100a, for example, is in a state where front license plates are not required, the operator may opt to turn the lights 250 off so that the license plate 10 is less visible. In some cases, the display system 200 is completely dark when the lights 250 are off, making the outer surface 110a of the vehicle 100a appear completely continuous with no window. For example, the window 210 may be formed from a material, e.g., glass or plastic, with a smoked appearance which makes the license plate 10 less visible until the lights 250 are turned one. In some cases, the window 210 may include a material that adjusts its translucence in response to changing light conditions in the environment to improve visibility of the license plate 10 in darker conditions.

To accommodate the display system 200, an aperture is formed in the outer surface 110a of the vehicle 100a. For example, the aperture may be formed in a nose cone that is attached to the front of the vehicle 100a. The window 210 is then fitted to the aperture, e.g., using adhesives or other fastening techniques. The license plate 10 is then positioned inside the vehicle 100a and behind the window 210 with the attachment mechanism 240, where it is visible from outside the vehicle 100a through the window 210. In certain implementations, the display system 200 is installed by the vehicle manufacturer, so the corresponding vehicle part, e.g., the nose cone, is originally manufactured to accommodate the display system 200. In other implementations, the vehicle owner installs the display system 200 as an after-market product, so the corresponding vehicle part may need to be retrofitted to accommodate the display system 200. As an after-market product, the window 210 may be more generically configured so that it can conform to the shapes of a larger variety of vehicles.

As described above, bumpers are now covered with a skin that is shaped and colored to complement the general aesthetic features of the vehicle. This trend accommodates implementation of the display systems described herein as the skins covering aspects of vehicles are more easily detachable.

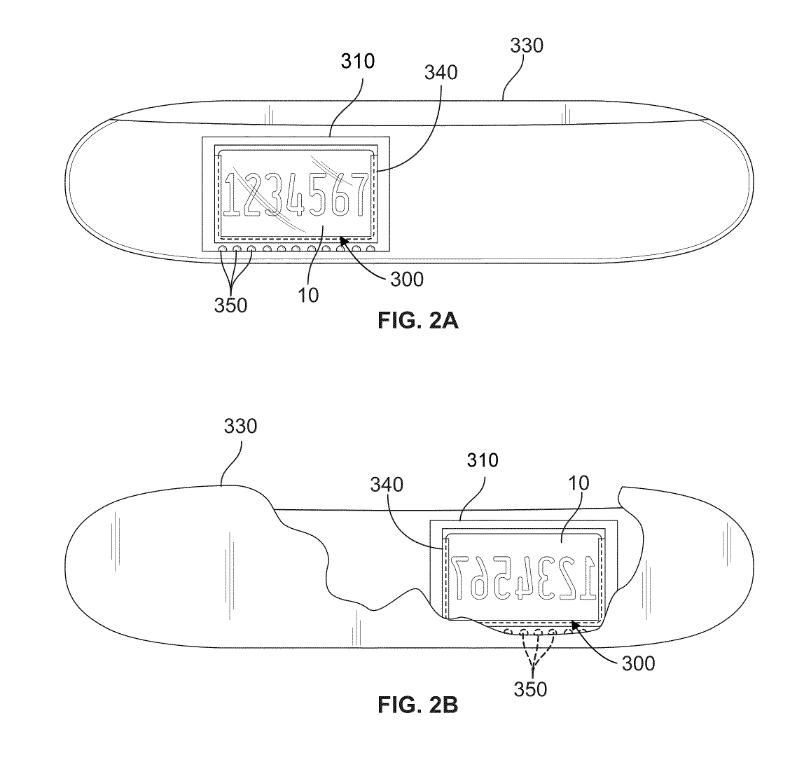

As described previously, the attachment mechanism 240 may couple the license plate 10 directly to the window 210 or to a structure of the vehicle 100a. In other embodiments, a display system may include a supporting structure that supports the attachment mechanism. For example, FIGS. 2A-B respectively illustrate front and back view of an example display system 300 that includes a window 310 that is disposed along the outer surface 110a of a vehicle and a supporting structure 330 that is disposed inside the vehicle. The supporting structure 330 defines a recess behind the window 310 and supports attachment mechanisms 340 which receive and position the license plate 10 behind the window 310. The recess defined by the supporting structure 330 provides sufficient space to accommodate the license plate 10 as well as other accessories. As shown in FIGS. 2A-B, the attachment mechanisms 340 include bracket structures that may be coupled to the supporting structure 330. However, the attachment mechanisms 340 may employ any number and combination of screws, nuts/bolts, pins, magnets, adhesives, brackets, snap mechanisms, or other fastening techniques to engage different portions, e.g., sides, corners, etc., of the license plate 10. The display system 300 may also include one or more lights 350 to illuminate the license plate 10.

Like the window 210 described above, the window 310 is contoured to be consistent with, or otherwise complement, the contours of the surrounding outer surface of the vehicle. In addition, the window 310 may employ any combination of tints or colors, and different portions of the window 310 may have varying levels of opaqueness/transparency.

As shown in FIG. 2A-B, the supporting structure 330 may also provide a background behind the window 310, which can be seen partially through the window 310 and around the license plate 10. As such, the supporting structure 330 prevents the interior of the vehicle, e.g., engine components, from being visible. The color of the background may also complement the outer surface 110a of the vehicle.

According to the aspects of the present invention, the window of a display system may form any sized area along the outer surface of the vehicle. Referring to FIG. 3, another example of a display system 400 is illustrated, where a large part, e.g., the nose cone, of a vehicle 100b may be defined by a window 410. In other words, the window 410 extends over an area of the front of the vehicle 100b. As shown in FIG. 3, portions of the window 410 are substantially opaque except where the accessories, such as the license plate 10, are displayed. For example, the window 410 may have a gradient of opacity, where the window 410 appears darker or more opaque at greater distances from the periphery of the license plate 10 and but gradually appears lighter and more transparent at distances closer to the portion where the license plate 10 is displayed.

Alternatively, the window 410 may be substantially transparent, but an opaque background, e.g., of a supporting structure, may be placed behind the window 410 to make the window 410 appear substantially opaque from outside the vehicle 100b. The license plate 10 is then positioned between the background and the window 410. Or cut-outs may be formed in the background and the license plate 10 may be positioned in the cut-outs so that they are visible through the background as well as the window 410.

As described above, vehicle owners may also want to attach bumper stickers to their vehicles. Because bumper stickers are placed onto the outer surface of the vehicle with an adhesive, they are semi-permanent and cannot be selectively removed and placed back onto the vehicle. According to aspects of the present invention, display systems allow accessories, such as bumper stickers, to be displayed without requiring them to be attached to the outer surface of the vehicle with an adhesive. Like the license plate 10 shown in the previous embodiments, a display system can hold a sign with text or images that are displayed like a bumper sticker though the window of the display system. Advantageously, by placing the sign inside the vehicle and behind the window, the sign cannot be removed, defaced, or otherwise vandalized.

Although bumper stickers may allow the vehicle owners to customize or personalize their vehicles, they may detract from the original aesthetically appealing features of the vehicles. In further embodiments, the display system may be operable to make the sign selectively visible. As described above, lights may be operated to make the sign more or less visible. Alternatively, an electronic or mechanical screen may be operated to cover the window from the inside of the vehicle to block visibility.

Referring again to FIG. 3, at least a section of the window 410 of the display system 400 is formed from a material that can be operated to make the material selectively translucent in varying amount. For example, materials, such as those that are sometimes referred to as smart glass or excitable glass, can be selectively darkened by applying a current to the materials. For example, an accessory 420 is disposed behind the window 410 for selective display through the window 410. The portion of the window 410 corresponding to the accessory 420 includes electrically controllable glass. As shown in FIG. 3, the window 410 is darkened in this portion to hide the accessory 420 or make it less visible. The display system 400, however, includes one or more control circuits 460 that provide a control for changing the translucence of the window 410 to reveal the accessory 420. For example, a driver may operate the control circuit 460 on an instrument panel in the cabin of the vehicle 100b to deliver a current to the window 410 to change the translucence.

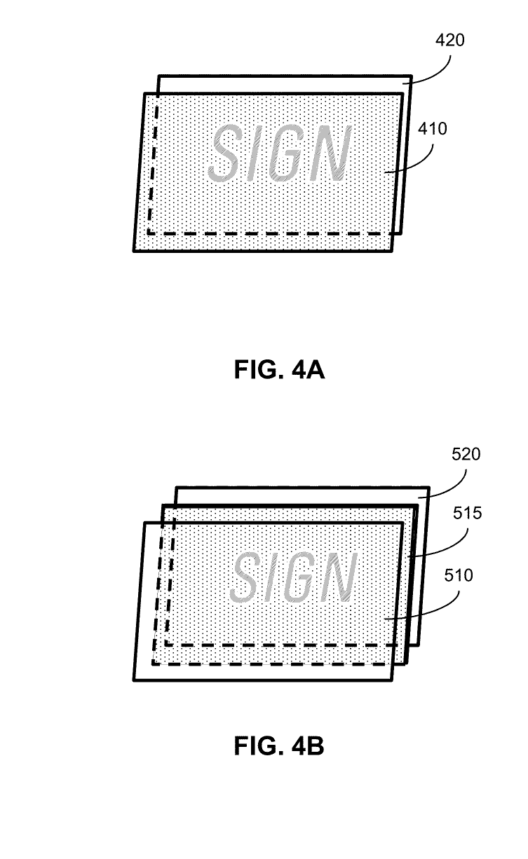

FIG. 4A illustrates the configuration of FIG. 3 where the window 410 itself is formed from a material of controllably varying translucence and the accessory 420 (e.g., a sign) is disposed directly behind the window 410. As shown in FIG. 4B, however, alternative embodiments may employ a window 510 that is generally translucent, but an intermediate panel 515 of material of controllably varying translucence is disposed between the window 510 and an accessory 520 (e.g., a sign). The panel 515 is coupled to one or more control circuits that provide a control for changing the translucence of the panel 515 to reveal the accessory 520. Advantageously, the configuration shown in FIG. 4B allows the panel 515 to be employed only when variable translucence is desired, thereby avoiding the cost of universally forming the window 510 from more expensive materials even when variable translucence is not always desired.

In some cases, a vehicle owner may be required to display identification on the vehicle when driving into and on a secure facility. For example, military personnel may be required to display identification showing their rank or position while driving on a base. However, military personnel may want to be more discrete when driving off base. According to aspects of the present invention, military personnel can conveniently make the identification selectively more or less visible when on or off base. Thus, changing the visibility through the window allows certain accessories to be used discretely.

Often, vehicle owners may want to place more than one bumper sticker on the vehicle to express different messages. Placing many bumper stickers is more likely to detract from the original aesthetically appealing features of the vehicles. Thus, according to aspects of the present invention, a display system may hold an electronic display that can be controlled to show different text or graphic images through the window. The electronic display may be similar to the controllable displays of a computer tablet. In some aspects, the electronic display may act as an electronic bumper sticker that allows vehicle owners to customize or personalize their vehicles with different messages without requiring them to cover large areas of the vehicle with many bumper stickers or other permanent attachments which cannot easily be removed or changed. In one implementation, a vehicle owner can use the electronic display to show support for more than one sports team without using many unsightly bumper stickers. For example, during the winter, the vehicle owner may configure the electronic display to show a logo for a favorite football team, while in the summer, the vehicle owner may configure the display to show a logo for a favorite baseball team. Meanwhile, the electronic display can also be configured to show other types of messages at other times.

In other embodiments, vehicle owners may use the electronic display to display advertising. In further implementations, vehicle manufacturers may use the electronic display to show graphics as additional aesthetic features for their vehicles. In yet further aspects, government bodies may implement electronic license plates that are securely operated to display and update vehicle registration information.

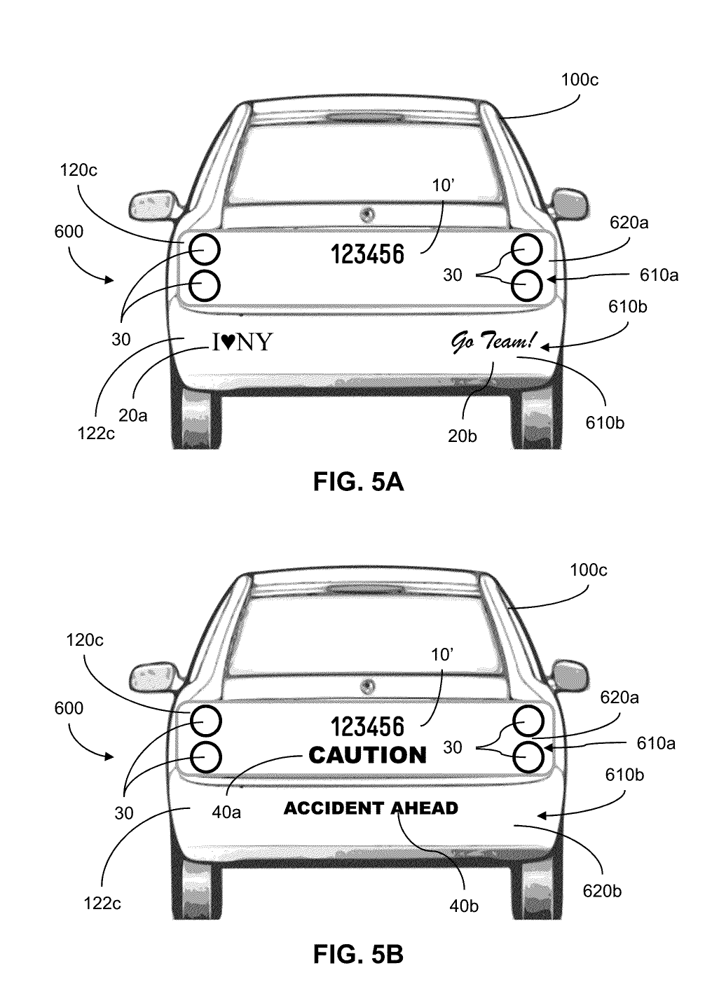

In yet other embodiments, the electronic display may be employed to display license plate information and/or other vehicle registration information. (An example of an electronic license plate is described below with reference to FIGS. 5A-B.) Such an electronic display may be issued by a government body or provided by the vehicle manufacturer or other authorized party. The license plate/registration information can be secured on storage media for the electronic display according to any combination of data security techniques to prevent display of invalid information. Furthermore, to prevent fraud, only authorized parties can access or modify the license/registration plate information. In some cases, the information is only displayed as long as the license plate and/or registration have not expired. When the license plate and/or registration expire, the electronic display may become deactivated or the electronic display may otherwise visually indicate that the license plate and/or registration has expired, for example, by causing the information to flash, change color, etc. Such visual indication allows law enforcement to identify vehicles with expired license plates and/or registrations. Advantageously, the license plate/registration information may change according to the location of the vehicle (determined, for example, by global positioning system (GPS)) if the vehicle is registered in different jurisdictions (e.g., states). A freight truck, for example, which may typically have multiple license plates mounted on its body can more simply employ an electronic display that shows the necessary license plate/registration information as the truck moves through different jurisdictions.

Indeed, referring to FIG. 3, the accessory 420 in the display system 400 may include an electronic display that is selectively controlled to show any text or graphic images. Additionally, the accessory 420 may be selectively hidden by controlling the translucence through the window 410. As described above, the display system 400 includes one or more control circuits 460 that provide a control to change the translucence of the window 410. The one or more control circuits 460 may also include a control to change the text or graphic images on the electronic display. The control for the electronic display may be a touch screen that provides a keyboard to enter text as well as graphical tools to create images. Furthermore, the control for the electronic display may be connected (wirelessly) to a network, e.g., the Internet, to allow content to be downloaded to the electronic display. Alternatively, the electronic display may include onboard circuitry that provides unchangeable content for the electronic display, e.g., static graphic designs generated by vehicle manufacturers.

In addition to providing electrical/electronic signals to the window 410 and/or the electronic display, the one or more control circuits 460 may be used to control other electric/electronic accessories, such as radar detectors, transponders, etc., in the display system 400.

Referring to FIGS. 5A-B, another implementation of an electronic display is employed in a display system 600. The display system 600 includes a first window 610a and a second window 610b that extend across areas of the rear of a vehicle 100c. As with the windows described above, the first window 610a and the second window 610b are contoured to be consistent with, or otherwise complement, the contours of the surrounding outer surface of the vehicle 100c. The first window 610a and the second window 610b respectively cover a first electronic display 620a and a second electronic display 620b, which also extend across areas of the rear of the vehicle 100c. The electronic displays 620a, b are coupled to the vehicle 100c by attachment mechanisms as described above and integrated into the general desired aesthetic scheme of the vehicle. As shown, the first window 610a and the first electronic display 620a are configured to follow the desired shape of the trunk lid 120c of the vehicle 100c. Meanwhile, the second window 610b and the second electronic display 620b are configured to follow the desired shape of the bumper 122c of the vehicle 100c. It is understood that each electronic display 620a or b may be defined by a combination of smaller electronic displays so that the electronic display 620a or b may be configured to follow the desired shape of the trunk lid 120c or bumper 122c, respectively. In addition, it is also understood that any number and combination of electronic displays may be employed in other embodiments.

The electronic displays 620a, b may be LED displays, for example, that can be controlled to display any combination of text or graphic images through the windows 610a, b, anywhere along the rear of the vehicle. For example, as shown in FIG. 5A, the first electronic display 620a displays license plate information 10′, while the second electronic display 620b displays custom messages 20a, b similar to those that may appear on bumper stickers. As described above, custom messages can be easily modified on the electronic displays 620a, b.

Because the displays 620a, b extend across the rear of the vehicle, they can display different information and provide different features across the rear of the vehicle. Indeed, as FIGS. 5A-B illustrate, the first electronic display 620a can be employed to provide brake lights 30 for the vehicle, thereby obviating the need for conventional break lights to be fitted to the vehicle 100c. As described above, with changes to the sizes of grills on the front of vehicles, designers have more area on the front of vehicles to exercise greater creativity. By eliminating the structure needed for conventional brake lights, aspects of the present invention also give vehicle designers greater flexibility to employ aesthetically appealing and distinctive designs on the rear of the vehicle. For example, the rear of the vehicle can be contoured in ways not previously contemplated due to the constraints imposed by the structure of conventional brake lights. Of course, in addition to providing brake lights 30, the electronic displays 620a, b can provide running lights, backing lights, turning lights, etc.

In some embodiments, the brake lights 30 are displayed to reflect the amount of braking by the vehicle 100c. For example, when the vehicle is experiencing light braking, the brake lights 30 may appear normally as shown in FIGS. 5A-B. However, if the vehicle 100c is experiencing heavier braking, the brake lights 30 may appear differently, e.g., brighter, larger, etc., so that other vehicles are more immediately alerted to the possible need to stop more quickly and to possible shorter stopping distances behind the vehicle 100c. Rather than merely showing the same brake lights for every type of braking, providing additional information on the amount of deceleration by the vehicle 100c may help prevent accidents. The brake lights 30 may be varied according to pressure applied to the brake pedal, in response to a signal from an accelerometer or other sensor on the vehicle 100c, etc.

As shown in FIG. 5B, the information provided by the electronic displays 620a, b can be changed. Although the first electronic display 620a still provides license plate information 10′ and the brake lights 30, the first electronic display 620a now displays a “CAUTION” message. Meanwhile, the second electronic display 620b no longer shows the custom messages 20a, b and now displays an “ACCIDENT AHEAD” message. Together the electronic displays 620a, b can display important traffic-related information to drivers behind the vehicle. In addition to alerting drivers to accidents on the road, the electronic displays 620a, b can alert other drivers of weather-related (e.g., slippery) conditions, road conditions (e.g., dirt, gravel, bumps, potholes, etc.), hazards in the road way, heavy traffic, construction zones, approaching toll plazas, changes in speed limit, school zones, changes in traffic pattern (e.g., detours, lane shifts, etc.), pedestrian traffic, etc. The electronic displays 620a, b may flash or otherwise highlight the traffic-related information in different colors (e.g., yellow) to draw the attention of other drivers.

As described above, the brake lights 30 may indicate the amount of braking by the vehicle 100c. The electronic displays 620a, b can be used to provide additional alerts in combination with the brake lights 30. For example, if the vehicle 100c is experiencing extreme deceleration, e.g., in advance of an accident, the electronic displays 620a, b may flash a “STOP!” message and/or a large STOP sign image to draw the attention of other drivers more immediately and effectively. Or for example, if vehicle systems (e.g., traction control system, accelerometers, etc.) sense that the vehicle 100c is losing control, the electronic displays 620a, b may display similar alerts to other drivers.

In some embodiments, the information shown on the electronic displays 620a, b may be determined by information from systems based on global positioning system (GPS). For example, if a GPS system determines that the vehicle 100c is located on a highway with light traffic, but the car is traveling at speeds significantly below the speed limit, the electronic displays 620a, b may flash a “SLOW VEHICLE” message to alert other drivers of the slower moving vehicle 100c.

In addition, other less important information, such as the custom messages 20a, b, can be removed from the electronic displays 620a, b to ensure other drivers are not distracted from the alert. In response to alerts, other drivers may reduce their speed and/or take other actions to ensure safer passage on the road. The driver of the vehicle may manually control the electronic displays 620a, b to display such alerts. Additionally or alternatively, the electronic displays 620a, b may respond to information or signals broadcast or transmitted by roadway authorities, other municipal agencies, traffic services, navigation systems, and/or other vehicles. It is also contemplated that such traffic-related information can be passed wirelessly (e.g., radio frequency (RF)) from vehicle to vehicle so that the information can be passed along to drivers farther down the road. In addition to displaying traffic-related information, the electronic displays 620a, b can also display distress information if the vehicle is disabled or if there is a medical or other emergency in the vehicle. Passing drivers can then stop to assist or call authorities for help. When the alerts are no longer required, the electronic displays 620a, b can revert back to a default state as shown, for example, in FIG. 5A.

As described above, aspects of the display systems may employ features that are selectively controlled, e.g., the lights 250, the window 410 or the panel 515 formed from a material of controllably varying translucence, or the electronic display 620. Although such features may be controlled directly by the vehicle operator, e.g., via the control circuits 460, they may also be controlled automatically as a function of time and/or location. For example, control circuits with a clock may be programmed to display, on the electronic display 620, an advertisement for a restaurant during lunch time. Or for another example, control circuits with global positioning system (GPS) may be programmed to turn off the lights 250 or make the window 410/panel 515 opaque in order to make a license plate less visible when the control circuits determine that the vehicle is in a state that does not require a front license plate to be displayed. Alternatively, the features of the display systems may be controlled wirelessly (cellular, RF, etc.) from an external device, such as a transponder (e.g., key fob control), smart phone, computer tablet, etc.

While the present disclosure has been described in connection with aspects of a number of exemplary embodiments, the present disclosure is not so limited, but rather, covers various modifications, and equivalent arrangements. In addition, it is understood that the features described are not limited to the specific embodiments described, but any number of these features may be combined in any way in other embodiments according to the principles of the presently disclosed subject matter.

What is claimed is:

1. A system for displaying accessories from a vehicle, the system comprising:
a window configured to be disposed along an outer surface of the vehicle, the window including an at least partially translucent portion; and
an attachment mechanism configured to secure an accessory inside the outer surface of the vehicle and behind the window of the display system, the attachment mechanism positioning the accessory relative to the window so that the accessory is visible from outside the outer surface of the vehicle through the at least partially translucent portion,
wherein the accessory displays text or graphic images.

2. The system of claim 1, wherein the attachment mechanism is coupled directly to the window.

3. The system of claim 1, further comprising a supporting structure that is configured to be disposed inside the outer surface of the vehicle, the supporting structure supporting the attachment mechanism.

4. The system of claim 1, further comprising one or more lights configured to illuminate the accessory.

5. The system of claim 1, wherein the window includes an opaque portion around the at least partially translucent portion.

6. The system of claim 5, wherein the opaque portion includes a gradient of opacity that transitions into the at least partially translucent portion.

7. The system of claim 1, wherein the window is tinted with one or more colors.

8. The system of claim 1, wherein the accessory is a license plate.

9. The system of claim 1, wherein the accessory is an electronic display that displays changeable text or graphic images through the at least partially translucent portion.

10. The system of claim 1, wherein the at least partially translucent portion includes a material that is configured to be selectively controlled to change translucence.

11. The system of claim 10, further comprising a control that delivers current to the material to change the translucence.

12. The system of claim 1, further comprising at least one additional attachment mechanism, wherein the window includes at least one additional at least partially translucent portion, the at least one additional attachment mechanism being configured to secure at least one additional accessory behind the at least one additional at least partially translucent portion.

13. The system of claim 1, wherein the window is configured to be disposed along an outer surface of a nose cone of the vehicle.

14. A method for assembling a system for displaying accessories from a vehicle, the method comprising:
providing a window along an outer surface of the vehicle, the window including an at least partially translucent portion; and
securing, with an attachment mechanism, an accessory inside the outer surface of the vehicle and behind the window, the attachment mechanism positioning the accessory relative to the window so that the accessory is visible from outside the outer surface of the vehicle through the at least partially translucent portion,
wherein the accessory displays text or graphic images.

15. The method of claim 14, wherein the attachment mechanism is coupled directly to the window.

16. The method of claim 14, wherein the accessory, when secured with the attachment mechanism, is coupled to a supporting structure inside the outer surface of the vehicle.

17. The method of claim 14, further comprising positioning one or more lights to illuminate the accessory.

18. The method of claim 14, wherein the window includes an opaque portion around the at least partially translucent portion.

19. The method of claim 14, wherein the accessory is an electronic display that displays changeable text or graphic images through the at least partially translucent portion.

20. The system of claim 14, wherein the at least partially translucent portion includes a material that is configured to be selectively controlled to change translucence.
